(19) United States
(12) Patent Application Publication
(10) Pub. No.: US 2005/0244215 A1
(43) Pub. Date: Nov. 3, 2005

(54) Assembly of structural parts

(75) Inventors: Maurice Prat, Toulouse (FR); Gerard Navas, Orvault (FR)

Correspondence Address: STEVENS DAVIS MILLER & MOSHER, LLP, 1615 L STREET, NW, SUITE 850, WASHINGTON, DC, 20036, US

(73) Assignee: AIRBUS FRANCE, Toulouse (FR)

(21) Appl. No.: 11/111,926

(22) Filed: Apr. 22, 2005

(30) Foreign Application Priority Data
Apr. 28, 2004 (FR) 04 04495

(51) Int. Cl. B60J 1/00

(52) U.S. Cl. 403/268

(57) ABSTRACT

Assembly of structural parts. The method of assembly consists in: laying a layer of adhesive material between facing surfaces of said parts, forming an assembly plane; and inserting and bonding, in a hole made in said structural parts transversely to said assembly plane, a joining element consisting of a peg made of a material similar to that of said structural parts.

The present invention relates to an assembly, by means of adhesive bonding and joining elements, of at least two structural parts to be assembled. The invention applies more particularly, but not exclusively, to the assembly of structural elements made of composite material.

It is known that to assemble two structural parts placed one against the other at least via respective zones on their surfaces, adhesive bonding can advantageously be used since this method of assembly meets the desired and set requirements (type of load to be transferred between the parts, materials and field of application of the parts, etc.). Indeed, assembly by adhesive bonding is clearly advantageous in light of its intrinsic qualities such as a homogeneous join between the parts with a good load distribution, sealing between the parts, preservation of the characteristics of the parts, weight economy and a smooth surface.

However, the good load distribution achieved in a bonded assembly may lead, in fatigue, to ruptures as the parts become progressively debonded, in the absence of an obstacle to check this progression, even though the initial debonding is often due to a very localized secondary reason (peeling, bonding defect) not related to an overload on the join between the parts.

As a consequence, to overcome this problem and ensure reliable assembly, it has been proposed to combine bonding with joining elements, such as bolts, rivets or the like, distributed appropriately over the contacting bonded surfaces of the parts and passing through, with play, holes drilled beforehand in said parts, perpendicular to the bonding plane of their surfaces, and to their opposing surfaces, for compatibility with the nuts, screw heads or rivet seams.

While the assembly obtained per se, i.e. by means of adhesive bonding and joining elements, is particularly secure and reliable, a number of disadvantages do however arise, such as non-negligible additional weight (bolts or other metal elements), especially when the parts are made of composite materials, and an increase in costs and in assembly time. Moreover, such an assembly is unsightly because of the ends of the joining elements (heads, nuts or rivet seams) which project after assembly from the external surfaces of the parts, this being particularly detrimental when the structural parts form part of an assembly likely to be subjected to fluid flows or the like. Furthermore, despite the addition of joining elements, the static final tensile strength of such an assembly is not increased as the methods of assembly by means of adhesive bonding, on the one hand, and joining elements, on the other hand, are structurally separate from one another and therefore act independently of one another. Indeed, the load threshold at break usually accepted is that of the strongest method, i.e. either that of the adhesive bonding alone or that of the joining elements alone. Generally, the microslip threshold at break of the bonding plane following stressing is lower than the microslip threshold necessary for the complete loading of the fastening elements. Thus, after the adhesive material breaks, these continue alone until they too break. Thus, the strength of the assembly in this case is limited to that of the joining elements alone.

The aim of the invention is to overcome these disadvantages and it relates to a method of assembling at least two structural parts by means of adhesive bonding and joining elements, whose design makes it possible in particular to:
increase the intrinsic static final tensile strength of the assembly produced;
reduce the weight and cost of the assembly;
significantly eliminate premature breakages due to debonding at individual defective points in the main bonding plane;
achieve joins having a smooth surface finish.

To this end, according to the invention, the method of assembling at least two structural parts along an assembly plane consists in:
laying a layer of adhesive material between facing surfaces of said parts, forming said assembly plane; and
inserting and bonding, in a hole made in said structural parts transversely to said assembly plane, a joining element consisting of a peg made of a material similar to that of said structural parts.

Thus, whereas in the prior art the adhesive bonding and the joining elements act independently of one another, according to the invention, the methods of assembly by means of adhesive bonding of the parts and by means of joining elements also bonded to the parts are made integral, such that there is a considerable increase in the loads the assembly can withstand. Indeed, tests performed by the applicant have shown that, for an assembly which is bonded and equipped with bonded pegs secured to the parts via the adhesive layer, the loads withstood by the bonding plane and by the pegs were combined. Moreover, the production of the joining element in the form of a peg, particularly a cylindrical peg, is very simple and considerably reduces the costs of the fastening elements. Moreover, the homogeneity of the assembly is ensured by the fact that said peg is made of a material of the same nature as that of the structural parts to be assembled. For example, it may be a carbon-based composite material for any assembly whose structural parts are made of a carbon-fiber composite.

Furthermore, when the structural parts form part of a mobile assembly (aircraft, boat, pipeline, etc.) likely to be subjected to flows of fluid or the like, the end faces of the peg are advantageously placed in contact with the flow, substantially flush with the external surfaces of said structural parts. This may be achieved by preadjustment or final leveling. Thus, the flow along the external surfaces of the parts is not disturbed, optimizing the performance of the assembly, among other things. No additional drag is created by the joining elements and, compared with the elements usual in the prior art, there is a considerable weight saving.

The figures of the attached drawing will give a clear idea of how the invention may be embodied. In these figures, identical references denote similar elements.

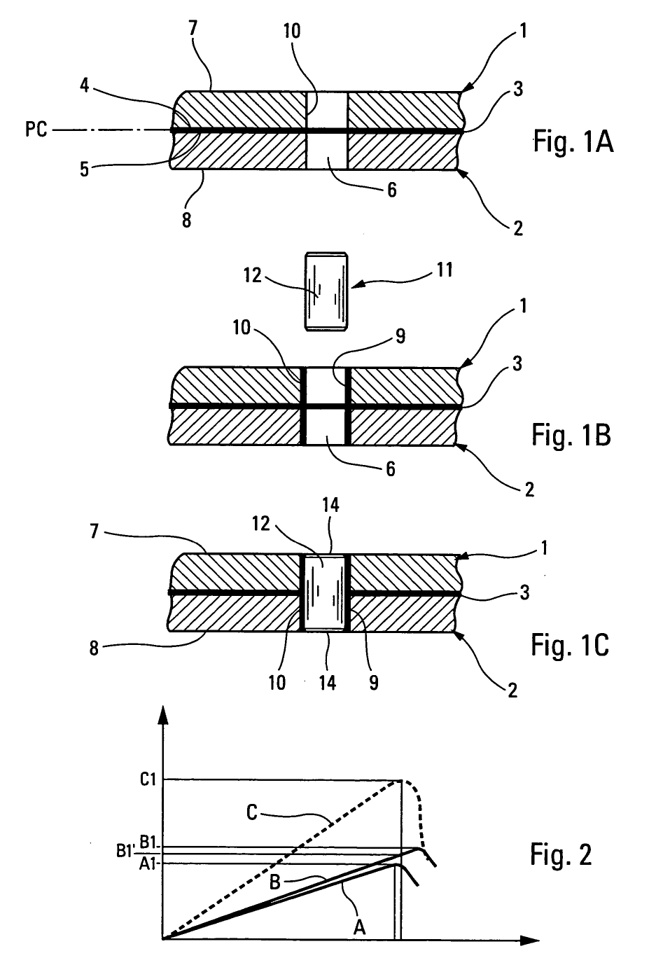

FIGS. 1A, 1B and 1C schematically show the main stages in the assembly method according to the invention, until assembly is obtained.

FIG. 2 is a graph showing the sliding of the assembly as a function of the load applied.

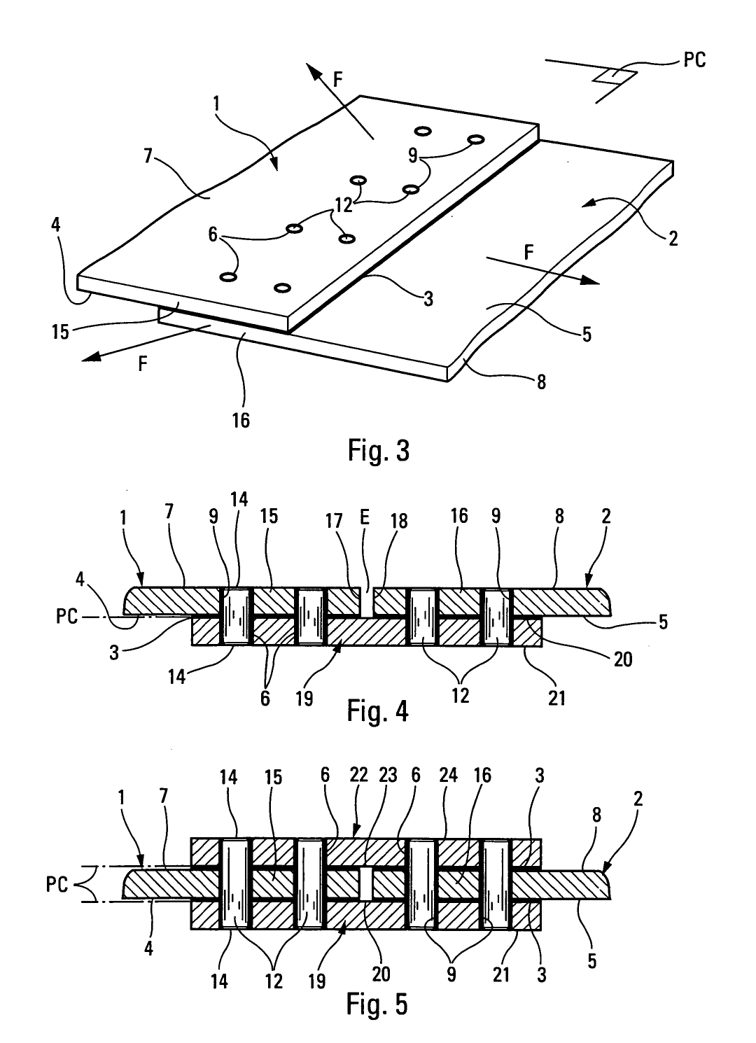

FIGS. 3, 4 and 5 show three application examples of the assembly according to the invention.

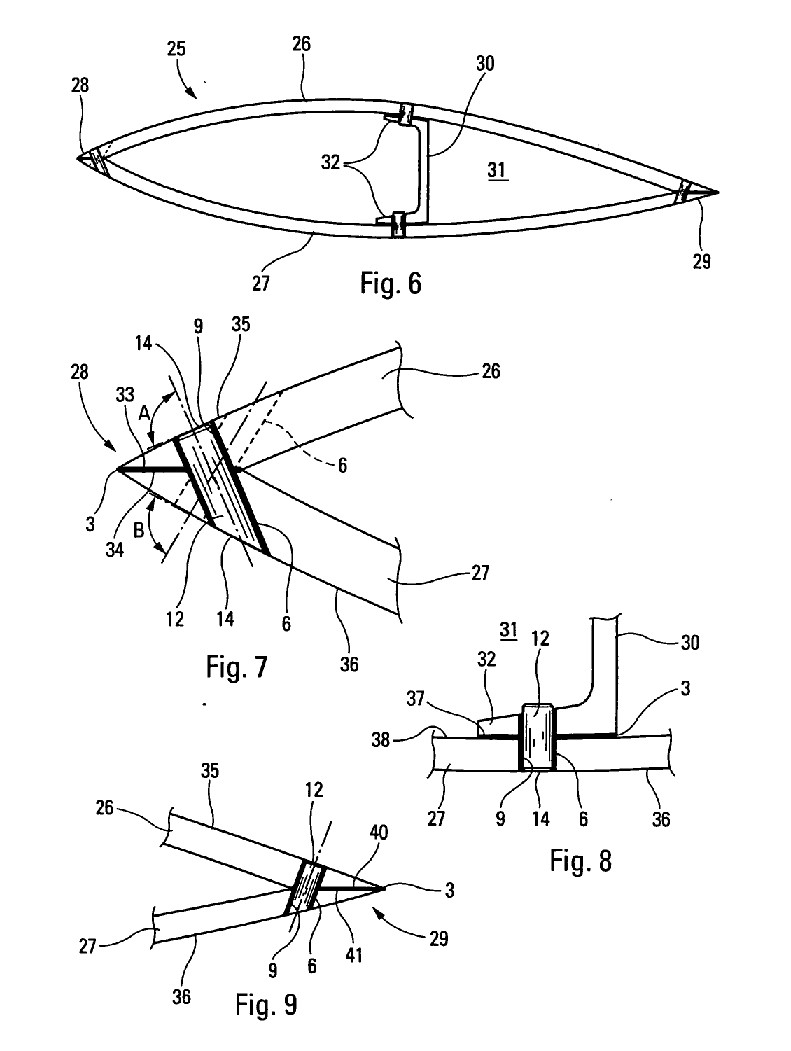

FIG. 6 schematically shows one application of the invention to the assembly of an aerodynamic profile.

FIGS. 7, 8 and 9 show the various assemblies needed for said profile.

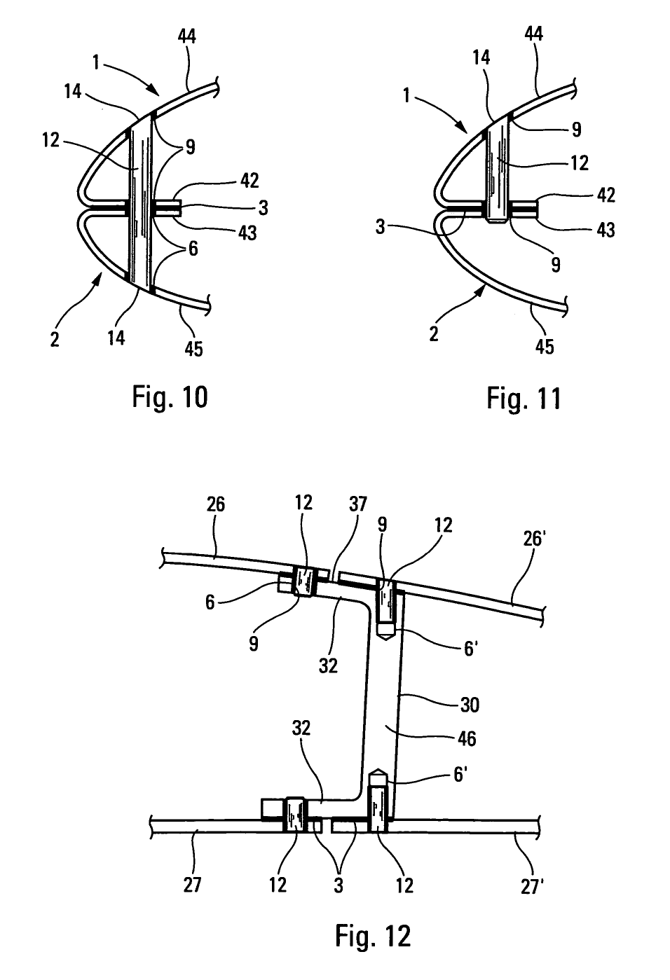

FIGS. 10, 11 and 12 show other possible assemblies according to the parts to be assembled.

The aim of the assembly method according to the invention is to fasten, by means of adhesive bonding and joining elements, at least two parts 1 and 2 shown schematically and partially as in FIG. 1A.

To this end, an adhesive layer 3 is laid between two internal facing surfaces 4 and 5 of the parts, bonding them together. Naturally, the surfaces to be bonded 4 and 5 were prepared for bonding beforehand and the adhesive layer 3 was then laid on one or other of the surfaces, or even both surfaces, of the parts which are then pressed together. It can also be seen in FIG. 1A that a hole 6 is made in the parts, in this case perpendicular to the bonding plane PC defined by the adhesive layer 3. This hole 6 passes right through and opens out at the respective external surfaces 7 and 8 of the parts. For the sake of clarity, in FIGS. 1A to 1C, only one hole has been shown.

According to the invention, as shown in FIG. 1B, an adhesive layer 9 is also laid along the side wall 10 of the hole 6, common to the parts 1 and 2. A joining element 11, to be inserted in the hole 6, is used to secure the join by bonding between the parts. This joining element 11 is in the form of a solid (or hollow) axisymmetric cylindrical peg 12 whose diameter is slightly smaller than the diameter of the hole to leave a film of adhesive layer 9 sufficient to bond it, and whose height is substantially the same in this example as the thickness of the parts to be joined together, such that the transverse end faces 14 of the peg are substantially flush with the external surfaces 7, 8 of the parts 1 and 2.

Thus, as shown in FIG. 1C, once inserted in the hole 6, the joining element 11 completely closes off said hole without projecting from the external surfaces 7, 8, being secured to the parts 1 and 2 by the adhesive layer 9. Thus, a particularly strong assembly between the parts is achieved through cooperation between the joining element 11 and the adhesive layers 3, 9, making it possible to significantly increase the level at break of the bonded join, as will be seen with reference to FIG. 2. In the figures, the thickness of the layers has been exaggerated.

The material of which the peg 12 consists is of the same structural nature as that of the parts so as to make the assembly as homogeneous as possible, and the kind of adhesive may be identical or different for the adhesive layers.

FIG. 2 shows the relationship between the slip of the join (abscissa) and the applied load (ordinate) up to the final break.

Line A shows the performance of the method of joining by means of adhesive bonding alone of the parts up to a maximum load A1, the loads appearing, from the start of stressing, in the bonding plane and increasing substantially linearly up to break of the adhesive.

Line B shows the performance of the method of joining by means of adhesive bonding alone of the pegs up to a maximum load B1, the loads appearing, unlike with screws or rivets, from the start of stressing and progressing linearly up to break.

The assembly according to the invention combines, right from the start, the performances of the two methods of joining which are integral with one another, in the manner shown on line C. Specifically, the loads of the method of joining by means of bonded pegs are added to those of the bonding plane up to the break of one of said methods. At that instant, the total load at break of the join is equal to the sum of the load at break of the weakest method (A1) plus the load taken by the other method at that instant (B1′) to reach a maximum C1.

An example of application of the method of the invention is shown in FIG. 3. The two structural parts 1, 2 are sheets or the like joined directly one on top of the other via two of their edges 15 and 16.

The assembly in this case consists of the adhesive layer 3, laid over the whole zone common to the two superposed edges 15, 16, and of two parallel rows of four pegs 12 each, which close off the transverse holes 6 in the sheets and are bonded to the side wall 10 of said holes by means of the adhesive layer 9. Various directions of shear stress contained in the bonding plane PC, to which the sheets 1, 2 may be subjected and which are borne by the assembly created are also shown by arrows F.

The two sheets 1, 2 partially shown in FIG. 4 are, in this example, placed end to end in the same plane with a space E separating their facing side faces 17, 18, and are linked to one another by an intermediate flat part or splint 19. This splint 19 presses, via one of its faces 20, against the corresponding undersides 4, 5 (in FIG. 4) of the respective edges 15, 16 of the sheets and the adhesive layer 3 bonds the splint 19 to the sheets 1, 2. Here again, two sets of two parallel rows of cylindrical pegs 12 are provided and close off the transverse holes 6 made in the edges of the sheets and the splint, being secured therein by the adhesive layer 9.

In the example shown in FIG. 5, the face 23 of another splint 22, similar to the one above, is attached by bonding, by means of an adhesive layer 3, to the corresponding top surfaces 7, 8 (in FIG. 5) of the respective edges 15, 16 of the sheets, symmetrically to the splint 19 with respect to the two aligned sheets. Two sets of two parallel rows of pegs 12 connect the two splints 19, 22 to the sheets 1, 2 via an adhesive layer 9 laid in each hole 6 passing perpendicularly through the two splints 19, 22 and the corresponding sheet 1 or 2.

Note, in FIGS. 4 and 5, that the transverse end faces 14 of the cylindrical joining pegs 12 lie substantially flush with the external surfaces of the assemblies made, i.e. level with the external surfaces 7, 8 of the sheets and with the other surface 21 of the splint for the assembly of FIG. 4, and level with the external surfaces 21 and 24 of the splints for the assembly of FIG. 5.

Another application of the invention is shown schematically in FIG. 6 which shows, in transverse section, an aerodynamic profile 25 in the form of a wing. This is composed of a curved top wall 26 forming the upper wing surface, a curved bottom wall 27 forming the lower wing surface, the two walls (which constitute the two parts to be assembled) being joined together via their edges defining the leading edge 28 and the trailing edge 29 of the profile, and at least one stiffening beam 30 of U-shaped cross section, provided in the interior space 31 of the profile and joining, via its side arms or flanges 32, the corresponding walls 26, 27. Advantageously, the fastening of the walls together at the edges 28, 29 and of the U-shaped beam to the walls implements the assembly method of the invention, there thus being no need for the end surfaces of the pegs to be parallel or for access to the internal face of the assembly.

FIG. 7 shows the assembly of the leading edge 28 of the aerodynamic profile 25. To this end, the layer of adhesive material 3 bonds the two flat facing internal surfaces 33, 34 of the top 26 and bottom 27 walls all along their length. Since the walls are curved, the holes 6 are drilled alternately perpendicularly from the tangential external surface 35 of one 26 of the walls and from the tangential external surface 36 of the other wall 27, in the manner shown by the angles A and B, all along the profile 25, in order to facilitate the insertion of the drill for making the holes. The holes 6 are spaced regularly along the leading edge 28 thus formed and pass completely through the thicknesses of the walls. The cylindrical pegs 12 are inserted and bonded by the layer of adhesive material 9 laid beforehand along the side wall of the holes.

The transverse end faces 14 of the pegs are prepared so as to lie flush with the external surfaces 35, 36 of the walls forming the structural parts 1, 2, or alternatively are leveled afterwards. This is particularly advantageous in this application of the invention to the bonding of aerodynamic or hydrodynamic profiles, since the transverse faces 14 of the pegs merge with the external surfaces 35, 36 of the profiles and do not form an obstacle to the flow of the fluid medium.

FIG. 8 shows the assembly of the stiffening beam 30 to the top 26 and bottom 27 walls. Each side wing 32 of the U-shaped beam is bonded, via its external face 37 facing the corresponding wall, to the internal surface 38 of the latter via the adhesive layer 3. Pegs 12 are placed in holes 6 passing through each “wall-flange” assembly and are bonded in the holes via the adhesive layer 9. The transverse end face 14 of the pegs, facing the external flow medium, is flush with the external surface 36 or 35 of the corresponding wall of the profile 25, so as not to disturb the flow, while the other transverse face may project slightly from the corresponding wing 32 as it emerges in the internal space 31 of the aerodynamic profile.

FIG. 9 shows the assembly of the trailing edge 29 of the aerodynamic profile 25. Like the leading edge, the internal facing surfaces 40, 41 of the walls 26, 27 are bonded via the adhesive layer 3 and then the pegs are pushed into the holes drilled 6, these pegs adhering to the side wall of the holes via the adhesive layer 9. The transverse end faces 14 of the pegs are, here again, made level with the external surfaces 35, 36 of the walls, in contact with the flow medium.

In this application, the pegs 12 are made of a carbon-based composite material, identical to the walls of the aerodynamic profile 25.

For example, in the case of the assembly of carbon elements, the pegs may be made from a majority of unidirectional fibers parallel to their longitudinal axis, with a small proportion of unidirectional fibers placed, to ensure good consistency of the whole, at an angle to the axis of the pegs, for example a few spiraled fibers at an angle of the order of 45 to 60 degrees. The pegs may also be made from braided fibers.

In the two examples shown in FIGS. 10 and 11 respectively, the two parts 1 and 2 to be assembled, such as sheets, have their edges 42, 43 folded back, and placed parallel one against the other so as to be bonded via the adhesive layer 3. In the example of FIG. 10, the peg 12 bonded via the adhesive layer 9 passes through the sheets 1, 2 and the parallel folded edges 42, 43 through coaxial aligned holes 6, and its transverse end faces 14 are beveled and lie flush with the external surfaces 44, 45 of the sheets, in contact with the flow medium. In the example of FIG. 11, the peg 12 joins together the two parallel folded edges 42 and 43 and emerges only in the upper sheet 1 with its transverse face 14 lying in the extension of the external surface 44.

In the example shown in FIG. 12, it can be seen that the same section or beam 30 of U-shaped cross section may be used to assemble, via the adhesive layers 3, 9 and the pegs 12, four external walls 26, 26′, 27, 27′, two 26, 26′ being placed in the extension of one another on the external face 37 of a first flange 32 of the beam, and two 27, 27′ on the second flange 32.

Two of the walls 26, 27 are assembled by the pegs 12 to the flanges themselves of the beam 30, in the same way as shown in FIG. 8, while the pegs 12 joining the two other walls are inserted in blind holes 6′ drilled in the base 46 of the beam. The results obtained with such an assembly are naturally identical functionally and structurally to assemblies with through holes.

Moreover, although the axisymmetric peg shown in the figures is cylindrical, it could be conical, which would prevent the adhesive from leaking out of the hole.

The main advantages of the invention are as follows:
better reliability of the assembly in fatigue;
significant increase in the final static break level;
absence of projections or discontinuities on the surface (countersink, driving recess, nut, rivet seam, etc.);
weight saving;
possibility of applying the invention to all bonded joins, whatever the relative angles of the surfaces to be assembled or whatever their level of accessibility.

1. A method of assembling at least two structural parts (1, 2) along an assembly plane, this method consisting in:
laying a layer of adhesive material (3) between facing surfaces of said parts, forming said assembly plane; and
inserting and bonding, in a hole (10) made in said structural parts transversely to said assembly plane, a joining element (11) consisting of a peg (12) made of a material similar to that of said structural parts.

2. The method as claimed in claim 1, wherein at least one transverse end face (14) of said peg (12) is made flush with an external surface of one of said structural parts (1, 2).

3. An assembly of at least two structural parts (1, 2) along an assembly plane, in which facing surfaces of said parts, forming said assembly plane, are bonded together and a joining element (11), consisting of a peg (12) made of a material similar to that of said structural parts (1, 2) is bonded in a hole (10) made in said structural parts transversely to said assembly plane.

4. The assembly as claimed in claim 3, wherein at least one transverse end face (14) of said peg (12) lies flush with an external surface of one of said structural parts (1, 2).
